(19) United States
(12) Patent Application Publication
(10) Pub. No.: US 2017/0150742 A1
(43) Pub. Date: Jun. 1, 2017

(54) METHOD FOR PRODUCING A SEMI-MOIST ANIMAL FEED PRODUCT AND SEMI-MOIST ANIMAL FEED PRODUCT FOR CARNIVOROUS ANIMALS

(71) Applicant: Hans-Juergen DEUERER, Bretten (DE)

(72) Inventor: Hans-Juergen DEUERER, Bretten (DE)

(21) Appl. No.: 15/310,134

(22) PCT Filed: May 19, 2015
(86) PCT No.: PCT/EP2015/060986

§ 371 Date: Nov. 10, 2016

(30) Foreign Application Priority Data
May 19, 2014 (DE) 10 2014 107 055.0

(51) Int. Cl. A23K 50/45; A23K 10/22; A23K 40/00; A23K 10/30; A23K 10/35; A23K 10/20; A23K 10/26

(52) U.S. Cl. CPC A23K 50/45; A23K 10/20; A23K 10/22; A23K 10/26; A23K 10/30; A23K 10/35; A23K 40/00

(57) ABSTRACT

The invention relates to a method for producing a semi-moist animal feed product. The invention also relates to a semi-moist animal feed product obtained by means of the claimed method, to the use of the claimed semi-moist animal feed product as feed for carnivorous animals.

The invention relates to a method for producing a semi-moist animal feed product. The invention further relates to a semi-moist animal feed product obtainable by the method according to the invention and to the use of the semi-moist animal feed product according to the invention as feed for carnivorous animals.

Carnivorous animals such as dogs and cats, which are kept as pets, are often not fed a species-appropriate diet.

In nature, these animal species chiefly feed on prey, i.e., they consume animal proteins in the form of meat.

In preparing feed products for carnivorous animals, it is nutritionally appropriate to provide a high protein content with a simultaneously low carbohydrate content.

In addition to the principal feed given as a main meal in the form of dry, semi-moist, or moist feed, there is also increasing consumer demand for snacks to be used for special functions such as dental care or for raising and training purposes.

Carnivorous animals not fed a species-appropriate diet have problems such as increased susceptibility to metabolic diseases.

There is therefore a need to provide a nutritionally suitable feed-particularly for use as a snack-that is readily accepted by carnivores.

The object is achieved by a method for producing a semi-moist animal feed product, characterized in that
a. a cutter for producing an animal feed precursor is charged with at least the following ingredients, which have a temperature equal to or lower than +25° C.: at least one component of the meat group,
b. the ingredients are minced to form an animal feed precursor with a moisture content of 30 wt % to 60 wt %,
c. the minced feed precursor is shaped without using heat, and
d. optionally, the shaped feed precursor is dried into a semi-moist animal feed product until a moisture content is reached of 15 wt % to 50 wt %, and preferably 20 wt % to 40 wt %.

By means of the method according to the invention, an animal feed product is provided that is characterized by being particularly well-accepted by carnivorous pets. Surprisingly, it was found that the method according to the invention provides a particularly soft texture of the meat-based animal feed product. In particular, processing without using heat, such as at temperatures between 1° C. and 30° C., and particularly at room temperature, leads to the particular softness of the semi-moist animal feed product according to the invention, as the protein is decomposed only by mincing, i.e., by means of special use of the cutter for crushing the meat, the cell structures are ruptured and proteins are denatured, and structures are produced such as those formed on disintegration of protein.

Here, the term “without using heat” is understood to mean that no heat is applied to the precursor during and/or before shaping. Shaping is carried out e.g. at temperatures of 1° C. to 30° C., e.g. 15° C. to 25° C.

A “semi-moist animal feed product” is understood to refer to an animal feed product having a content of approximately 15 wt % to approximately 50 wt % of water and at least 30 wt % of meat relative to the total weight of the feed precursor or the animal feed product.

“Meat” is understood to refer to all meat parts of slaughtered warm-blooded land animals, fresh or preserved by a suitable method, and all products of processing of the bodies of land animals that are allowed in animal feed processing.

In an advantageous embodiment, the meat content of the feed precursor is between 30 wt % and 95 wt %, preferably between 40 wt % and 80 wt %, and more preferably between 60 wt % and 70 wt %. This embodiment is advantageous in that the semi-moist animal feed product is consumed by animals particularly readily, wherein acceptance further increases with increasing meat content.

In an advantageous embodiment, the semi-moist meat-based animal feed product is shaped by means of a screw extruder, particularly a screw extruder from the firm Rheon®. Surprisingly, this type of shaping made it possible to achieve further improvement in the degree of acceptance of the feed product.

In a further advantageous embodiment, the ingredients for producing the feed precursor have a temperature in the range of −18° C. to +7° C. This embodiment is advantageous in that the mincing time required until the protein contained in the precursor disintegrates (i.e. denaturing of the proteins by destruction of the cell membrane) and a bonded feed precursor is produced is only approximately 5 to 15 minutes, e.g. 5 to 10 minutes. Accordingly, the method is particularly economical with respect to the required expenditure of time and energy. By means of mincing, this embodiment provides an animal feed precursor whose temperature is up to approximately 15° C.

In a further advantageous embodiment, additional cooling is carried out, for example by adding ice or cooling the cutter by means of cooling elements, so that a maximum temperature of approximately 5° C. is reached. At a maximum temperature of the produced feed precursor of approximately 5° C., the texture of said processor is particularly homogenous.

“Cutter” and “mincing” are understood in the present invention to mean that the components contained in the cutter are finely and minutely crushed. This means that the particle size distribution is in the range of 10 mm to 0.1 mm or smaller. Mincing is characterized by a process in which the cell membranes of as many cells as possible are damaged so as to obtain a fine, homogeneous mass. Corresponding “cutters” are known to the person skilled in the art. In this process, the blades are used at a speed of at least 60 rpm, for example at least 200 rpm, e.g. at least 2860 rpm. This causes at least partial denaturing of the proteins during mincing.

The moisture content of the feed precursor can advantageously be between 40 wt % and 50 wt %. The advantage of using a feed precursor with this moisture content of 40 wt % to 50 wt % is that no drying, or only extremely brief drying, is required. This allows the nutrients in the semi-moist animal feed product to be retained to the greatest extent possible.

In a further advantageous embodiment, drying of the shaped feed precursor until a moisture content of 5 wt % to 40 wt % is reached is advantageously carried out in a temperature range of 90° C. to 200° C. In the temperature range of 90° C. to 200° C., there is a favorable relationship between the time required to reach a moisture content of 5 wt % to 40 wt % and the energy required for drying.

For example, drying of the shaped feed precursor until a moisture content of 5 wt % to 40 wt % is reached can advantageously be carried out at approximately 135° C. Surprisingly, it was found that in this temperature range, the relationship between economically advantageous drying and the nutrient content of the semi-moist animal feed product according to the invention is most favorable.

In a further advantageous embodiment, the semi-moist meat-based animal feed product is shaped by means of a screw extruder, particularly a screw extruder from the firm Rheon®. Surprisingly, this type of shaping makes it possible to achieve further improvement in the degree of acceptance of the feed product.

In a further advantageous embodiment, the ingredients for producing the feed precursor are used in completely or partially frozen form. Surprisingly, it was found that shaping of such a feed precursor results in a particularly well-accepted texture.

In a further advantageous embodiment, the ingredients for producing the feed precursor are crushed before charging of the cutter by feeding them through one or a plurality of perforated disks. It has been found in this case that crushing before the mincing process provides a more homogenous feed precursor, and as a result, the mincing process does not have to be excessively prolonged, so that the animal proteins are retained as favorably as possible.

In a further advantageous embodiment, one or a plurality of components of the group of vegetables, cereal, potatoes, glycerol, salmon powder, cheese powder, rumen powder, and/or liver sausage are added to the ingredients for producing the feed precursor before mincing.

On the one hand, these further feed components provide better technical processing of the feed, in the sense that the feed precursor is easier to process because it is less tacky. Surprisingly, it was found that the tackiness of the feed precursor can be reduced by adding the above-mentioned further feed components to the ingredients for producing the feed precursor before the mincing process. On the other hand, for example, species-specific flavors can be produced.

In a further advantageous embodiment, additives commonly used in the animal feed industry are added. In particular, these are flavoring agents, natural or synthetic dyes, inactivated yeasts or yeast extracts, plant extracts and/or concentrates, preservatives, sugars, and/or functional ingredients. Functional ingredients are understood, for example, to be probiotics, but also vitamins, minerals, omega-3 fatty acids, probiotic dietary fiber, and probiotic microorganisms.

Preservatives such as potassium sorbate can be used in the method. For example, potassium sorbate can be used in a concentration of 0.1 wt % to 1 wt % relative to the total weight of the feed precursor. The addition of potassium sorbate in an amount of approximately 0.5 wt % relative to the total weight of the feed precursor results in a minimum shelf life of the semi-moist animal feed product according to the invention of approximately 15 to 18 months.

In order to improve binding of the feed precursor, animal byproducts, particularly cooked pork rinds or gelatin, may be used. Milk products or protein derived therefrom need not be used. This is advantageous with respect to possible intolerance to dairy products or milk protein.

In an advantageous embodiment, one, or simultaneously, a plurality of feed precursor(s) of different compositions are produced that are shaped into one or a plurality of strands. This shaping method is advantageous in that semi-moist animal feed products can be produced from a combination of two or more feed precursors.

From the standpoint of process engineering, single-strand shaping is the easiest to achieve. The advantage of multi-strand shaping can lie in the fact that a feed processor of particular nutritional value, for example, can be combined with a feed precursor that is particularly well-accepted by the target animal species.

In a further advantageous embodiment, in multi-strand shaping of the feed precursor, the strands are interwoven. This measure makes it possible to achieve multiple products of different shapes, particularly those in which two or more different animal feed precursors are concentrically arranged in the semi-moist animal feed product.

In a further advantageous embodiment, the semi-moist animal feed product is cooled to a temperature of 10° C. to 40° C., particularly to approximately 25° C., for example in a tunnel.

The semi-moist animal feed product according to the invention is obtainable by the method according to the invention.

In an advantageous embodiment, the semi-moist animal feed product according to the invention has breaking strength of between 28 kPa and 72 kPa and/or a compressive strength of between 112 kPa and 129 kPa. This breaking and compressive strength is the result of the particularly soft texture, which provides corresponding haptics.

In order to test breaking strength, the force required to cut through the sample was determined. The breaking strength of the sample was determined from the measured maximum force and cross-sectional area of the sample that was cut through.

A test piece approx. 26 mm in length, 19 mm in width, and 14 mm in height was tested. A further test piece was 120 mm in length, 22 mm in width, and 14 mm in height. The test pieces were dual-stranded, with one strand being arranged on the inner side. Measurement was carried out at 20° C. and a relative humidity of 55%.

The geometry of the plate for determination of breaking strength was as follows: width 80 mm, height 80 mm, cutting angle of 45°.

In order to test compressive strength, the force required to press a cylinder into the sample was determined, wherein the deformation of the sample to be tested was 50% of the sample height. The compressive strength of the sample was determined from the measured maximum force and the impinging cylinder area with a diameter of 20 mm, wherein only samples with a width greater than 15 mm were measured.

The sample and the measurement conditions were identical to those in the test of breaking strength.

The semi-moist animal feed product according to the invention advantageously has a fat content of between 8 wt % and 30 wt %, and particularly approximately 13 wt %, a protein content of between 10 wt % and 40 wt %, and particularly approximately 25 wt %, an ash content of between 2 and 10 wt %, and particularly approximately 6 wt %, and a pH of between 5 and 6.5—particularly 5.5. The effect of this composition is that such a semi-moist animal feed product provides particularly favorable nutrition for carnivorous animals.

In an advantageous embodiment, the predominantly meat-based animal feed product according to the invention has a moisture content of approximately 33 wt %. Semi-moist animal feed products with a moisture content of approximately 33 wt % show a particularly well-accepted texture.

In a further advantageous embodiment, in the semi-moist animal feed product according to the invention shaped into multiple, particularly concentric interwoven strands, in particular in feed precursors of different compositions, at least part of at least one inner strand is visible on the longitudinal side of the semi-moist animal feed product. This embodiment provides semi-moist animal feed products with a particularly high-quality appearance.

In a further advantageous embodiment, the semi-moist animal feed product according to the invention is cut into cubes or cuboids. Surprisingly, it was found that the particular “softness” of the semi-moist animal feed product according to the invention is particularly conducive to the feed shape of cuboids, i.e., the form of a cuboid provides a particularly well-accepted product based on the corresponding haptics.

In a further advantageous embodiment, the semi-moist animal feed product is sealed in a foil package, particularly a gas-tight foil package such as a tubular bag package or a hollow shell package. This embodiment is advantageous in that the moisture content that is required by process engineering and determines the texture of the semi-moist animal feed product is achieved for longer than the intended minimum shelf life of the product.

The semi-moist animal feed product can also be packaged or sealed under a protective atmosphere, for example in a nitrogen and/or carbon dioxide atmosphere, so that a minimum shelf life of 15 to 18 months is ensured.

With the method described above, a new semi-moist animal feed product is obtained that consists exclusively of meat, for example dried meat—optionally ground into meal—to at least 30 wt %, preferably between 30 wt % and 95 wt %, and more preferably between 40 wt % and 80 wt %, for example between 60 wt % and 70 wt % relative to the total weight of the feed precursor.

The predominantly meat-based animal feed product according to the invention can be or be produced in the form of pieces, for example in the form of bite-sized pieces.

The semi-moist animal feed product according to the invention can be dyed in one or multiple colors with natural dyes. It has been shown that this measure makes the product even more acceptable to the animal owner.

The semi-moist animal feed product according to the invention can also be combined with other feed products in sales units or be offered for sale as mixed animal feed. It can advantageously be offered as cat food, dog food, or feed for other carnivorous pets in the form of complete animal feed or snacks.

In the following, the invention is described in further detail with respect to an illustrative embodiment that serves only to explain a possible embodiment and by no means limits the scope of the invention.

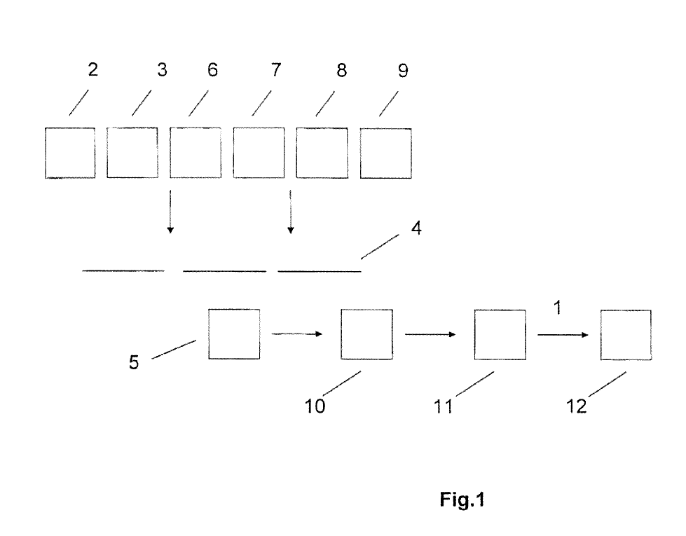

FIG. 1, which is the only FIGURE, shows a schematic diagram for producing a semi-moist animal feed product according to the invention. First, the ingredients of the group “meat” are placed in the cutter 5. These ingredients are located in containers 2 and optionally (if separate containers, e.g. for meat of different animal species, are provided) and are conveyed from there to the cutter 5. There are also further containers for vegetables 6 or cereal 7 or potatoes 8 or glycerol 9, which can be added to the meat-based ingredients. Further containers, e.g. for salmon powder, cheese powder, rumen powder, and liver sausage can be provided, the contents of which can be supplied to the cutter 5 via feed lines (the further containers and their feed lines are not shown in FIG. 1). 4 denotes perforated disks that are upstream from the cutter 5 and are used to crush at least the flesh-based products for producing the feed precursor.

If multiple animal feed precursors of different compositions are produced simultaneously, it is possible to shape multi-strand semi-moist animal feed products 1 having strands of animal feed precursors of different compositions. During shaping, for example by means of a former 10, particularly a screw extruder, the strands can be interwoven. This makes it possible to obtain a variety of semi-moist animal feed products 1 differing completely in appearance and haptics, for example products in which a part of at least one inner strand is visible on the longitudinal side of the semi-moist animal feed product 1. From the former 10, the shaped feed precursor is fed into a dryer denoted by 11. The size of the semi-moist animal feed products 1 obtained after drying is selected so that it can be optimally consumed by the respective carnivorous animal species; for example, the diameter for semi-moist animal feed products such as cat nibbles is approximately 1 cm, while the diameter for dogs can be approximately 2 to 4 cm. After leaving the dryer 11, the final product, i.e. the semi-moist animal feed product 1, is sent on to processing and/or packaging units, denoted here collectively by 12.

1. A method for producing a semi-moist animal feed product, comprising the steps of:
a) charging a cutter for producing an animal feed precursor with ingredients comprising at least one meat having a temperature equal to or lower than +25° C.,
b) mincing the ingredients to form an animal feed precursor with a moisture content of 30 wt % to 60 wt %,
c) shaping the minced feed precursor, without using heat, into a semi-moist animal feed product, and
d) optionally, drying the shaped animal feed product until a moisture content between 15 wt % and 50 wt % is reached.

2. The method according to claim 1, wherein the ingredients for producing the feed precursor are in a completely or partially frozen form.

3. The method according to claim 1, wherein one or a plurality of components selected from the group consisting of vegetables, cereal, potatoes, glycerol, salmon powder, cheese powder, rumen powder, and liver sausage are added to the ingredients for producing the feed precursor before mincing.

4. The method according to claim 1, wherein at least one additive selected from the group consisting of flavoring agents, natural or synthetic dyes, inactivated yeast or yeast extracts, plant extracts and/or concentrates, preservatives, sugars, and functional ingredients.

5. The method according to claim 1, wherein one, or simultaneously, a plurality of animal feed precursor(s) of different compositions are produced that are shaped into one or a plurality of strands.

6. The method according to claim 5, wherein, the plurality of strands are interwoven.

7. The method according to claim 1, wherein the semi-moist animal feed product is cooled to a temperature of between 10° C. and 40° C.

8. A semi-moist animal feed product, obtainable by a method according to claim 1.

9. The semi-moist animal feed product according to claim 8, wherein the animal feed product has a breaking strength between 28 kPa and 72 kPa and/or a compressive strength of between 112 and 129 kPa.

10. The semi-moist animal feed product according to claim 8, wherein said product has a fat content between 8 wt % and 30 wt %, a protein content between 10 wt % and 40 wt %, an ash content between 2 and 10 wt %, and a pH between 5 and 6.5.

11. The semi-moist animal feed product according to claim 8, wherein a plurality of animal feed precursors are produced that are shaped into one or a plurality of interwoven strands and at least a part of at least one inner strand is visible on the longitudinal side of the semi-moist animal feed product.

12. The semi-moist animal feed product according to claim 11, wherein the strands contain animal feed precursors of different compositions.

13. The semi-moist animal feed product according to claim 11, wherein the shaping is concentric shaping.

14. The semi-moist animal feed product according to claim 8, wherein said product is sealed in a foil package.

15. The semi-moist animal feed product according to claim 14, wherein said product is packaged in a gas-tight manner.

16. The method according to claim 1, wherein in step d) the shaped animal feed product is dried until a moisture content between 20 wt % and 40 wt % is reached.

17. The semi-moist animal feed product according to claim 14, wherein said product is sealed in a tubular bag package or a hollow shell package.
